(19) United States
(12) Patent Application Publication
(10) Pub. No.: US 2026/0108805 A1
(43) Pub. Date: Apr. 23, 2026

(54) HAPTIC DEVICE WITH MULTIPLE HAPTIC MODALITIES

(71) Applicant: INNOVOBOT LABS INC., Montréal (CA)

(72) Inventor: Danny GRANT, Laval (CA)

(21) Appl. No.: 19/120,521

(22) PCT Filed: Oct. 13, 2023
(86) PCT No.: PCT/CA2023/051367

§ 371 Date: Apr. 11, 2025

Related U.S. Application Data
(60) Provisional application No. 63/415,873, filed on Oct. 13, 2022.

(51) Int. Cl. A63F 13/285; A63F 13/24; G06F 3/01

(52) U.S. Cl. CPC A63F 13/285; A63F 13/24; G06F 3/016

(57) ABSTRACT

An ungrounded haptic device adapted to be held or worn by a user for simulating kinesthetic forces includes a skin stretch mechanism and at least one vibration generator. The skin stretch mechanism provides haptic shear forces to the skin of the user to simulate continuous and/or persistent forces. A vibration generator mounted to the haptic device provides haptic vibrations to the user to simulate transitory forces. Parameters of the haptic shear forces and parameters of the haptic vibrations are configured to operate complementarily to simulate the kinesthetic forces.

### CROSS-REFERENCE TO RELATED APPLICATIONS

The present application claims priority on U.S. Patent Application No. 63/415,873 filed Oct. 13, 2022, the entire contents of which are incorporated herein by reference.

### TECHNICAL FIELD

The disclosure relates generally to haptics and, more particularly, to systems and methods for providing users with haptic feedbacks.

### BACKGROUND

One challenge with creating fully realistic haptic interaction in virtual reality is creating kinesthetic forces in a large workspace, such as those that provide full limb extension, to the user. Kinesthetic forces are forces that may be continuously applied and can push or pull on the user in persistent fashion. This may be achieved with a grounded system, but generally involves a complex and expensive device that has a limited workspace. Improvements are therefore sought.

### SUMMARY

In accordance with one aspect, there is provided an ungrounded haptic device adapted to be held or worn by a user for simulating kinesthetic forces, the ungrounded haptic device comprising: a skin stretch mechanism mounted to the haptic device, the skin stretch mechanism providing haptic shear forces to the skin of the user; and a vibration generator mounted to the haptic device, the vibration generator providing haptic vibrations to the user; wherein parameters of the haptic shear forces and parameters of the haptic vibrations are configured to operate complementarily to simulate the kinesthetic forces.

The ungrounded haptic device as defined above and described herein may also include one or more of the following features, in whole or in part, and in any combination.

In some embodiments, the vibration generator comprises at least one localized vibration generator for providing haptic localized vibrations to simulate localized transitory forces.

In some embodiments, the localized vibration generator includes an actuator attached to an inner surface of a contact surface embedded in a housing of the haptic device.

In some embodiments, a suspension device interconnects the contact surface and the housing, the suspension device being configured to isolate vibrations generated by the localized vibration generator.

In some embodiments, the vibration generator comprises a body vibration generator for providing haptic body vibrations throughout the ungrounded haptic device. This may be used to simulate transitory forces and/or other haptic sensations.

In some embodiments, the vibration generator and the skin stretch mechanism operate concurrently during at least a portion of a total duration of simulation of the kinesthetic forces.

In some embodiments, the haptic vibrations are initiated concurrently with or after a starting time of the haptic shear forces.

In some embodiments, the maximum value of an amplitude of the haptic shear forces is greater than a maximum value of an amplitude of the haptic vibrations.

In some embodiments, a motor is mounted to the haptic device and coupled to skin stretch mechanism, the motor configured to induce a rotational motion to the skin stretch mechanism.

In some embodiments, the skin stretch mechanism comprises a rotating element having a skin-contacting projection thereon.

In some embodiments, the skin-contacting projection includes a surface feature and/or an eccentric portion extending radially outward from the rotating element.

In some embodiments, the skin stretch mechanism comprises at least one ring rotatably mounted to the haptic device.

In some embodiments, a converter interconnects the motor and the skin stretch mechanism, the converter configured for converting the rotation motion from the motor into at least one of: a translation motion; a pushing and pulling motion; and a scissor-like motion of the skin stretch mechanism.

In some embodiments, an impact actuator is mounted to the haptic device, the impact actuator providing an haptic impact impulse to the user to simulate an impact, wherein parameters of the haptic impact impulses, the parameters of the haptic shear forces and the parameters the haptic vibrations are configured to operate complementarily.

In some embodiments, a controller for controlling the skin stretch mechanism and the vibration generator to modulate the parameters of the haptic vibrations and the haptic shear force to simulate a contact event obtained from a simulator.

In accordance with another aspect, there is provided a method of providing a user with haptic feedback using an ungrounded haptic device, the method comprising: providing haptic shear forces to the skin of the user to simulate continuous and/or persistent forces; and complementarily with the providing of the haptic shear forces, providing haptic vibrations to the user to simulate transitory forces.

The method as defined above and described herein may also include one or more of the following features, in whole or in part, and in any combination.

In some embodiments, providing haptic vibrations further comprises providing haptic localized vibrations to simulate directional transitory forces.

In some embodiments, providing haptic vibrations further comprises providing haptic body vibrations to simulate transitory forces throughout the ungrounded haptic device.

In some embodiments, the method further includes modulating parameters of the haptic vibrations and the haptic shear force to simulate a contact event.

In accordance with another aspect, there is further provided a haptic device, comprising: a housing adapted to be held or worn by a user; a skin stretch mechanism mounted to the housing, the skin stretch mechanism providing shear forces to the skin of the user to simulate continuous and/or persistent forces; and at least one of: a vibration generator mounted on the housing for providing vibrations to the user; and an impact actuator for providing a haptic impact impulse to the user; wherein parameters of the haptic shear forces and parameters of at least one of the haptic vibrations and the haptic impact impulse are configured to operate complementarily.

### BRIEF DESCRIPTION OF THE DRAWINGS

Reference is now made to the accompanying figures in which:

FIG. 1 is a schematic block diagram of a haptic device in accordance with an embodiment;

FIG. 2 is a schematic front view of a haptic device in accordance with an embodiment;

FIG. 3 is a schematic front view of a haptic device in accordance with an embodiment;

FIG. 4 is another schematic front view of a haptic device in accordance with an embodiment;

FIG. 5 is another schematic front view of a haptic device in accordance with an embodiment;

FIG. 6 is another schematic front view of a haptic device in accordance with an embodiment;

FIG. 7A-7D are schematic front, side, top and perspective views, respectively, of a haptic device in accordance with an embodiment, a portion of the outer casing of the haptic device being removed in FIGS. 7A-7C for ease of comprehension;

FIGS. 8A and 8B are top and cross-section views, respectively, of a localized vibration generator;

FIGS. 9A and 9B are a graph showing profiles of multimodal haptic stimuli generated by the haptic device of FIGS. 1-7; and

FIG. 10 is a schematic representation of a computing device to be used with the haptic device of FIGS. 1-7.

### DETAILED DESCRIPTION

This present disclosure is directed at creating representative sensations that includes all the elements of a full realistic haptic interaction by using a haptic device. The haptic device as described herein is an ungrounded device, and my include for example a handheld device (e.g. a game controller, a computer mouse, a phone, or other handheld devices, including for example those used in the context of a virtual reality system) or a wearable device that is adapted to be worn by the user. Such a wearable device may include, for example, a wrist strap, a glove, a head band, a helmet, etc.

There are several primary means via which kinesthetic devices apply forces to a user. The force applied has a magnitude, a duration, and a direction (e.g., 6 degrees of freedom (DOF)). For example, a user is moving an end effector of a 3-DOF kinesthetic device in a virtual reality simulation. In the simulation, the user may be holding a weapon such as a sword and is in a room with a table. The user may move the sword in free space; strike the table; and continuously push down on the table with the sword.

While moving a real object in free space, the user may feel the gravity of the object as well as the inertia of the object as the user is changing directions. When striking the table or impacting the object against a surrounding element, the user feels the impact of the collision through the handle in a direction that is opposite the direction of the impact. While continuously pushing a real object on the surrounding element, the user feels a kinesthetic force that is opposite of the direction the user is pushing.

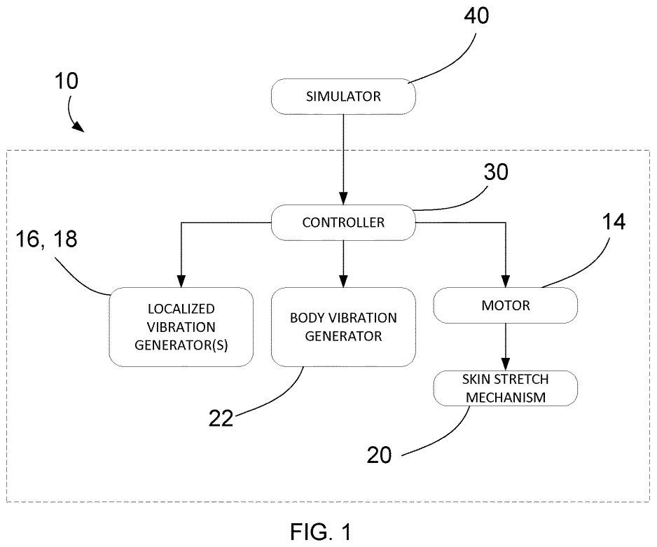

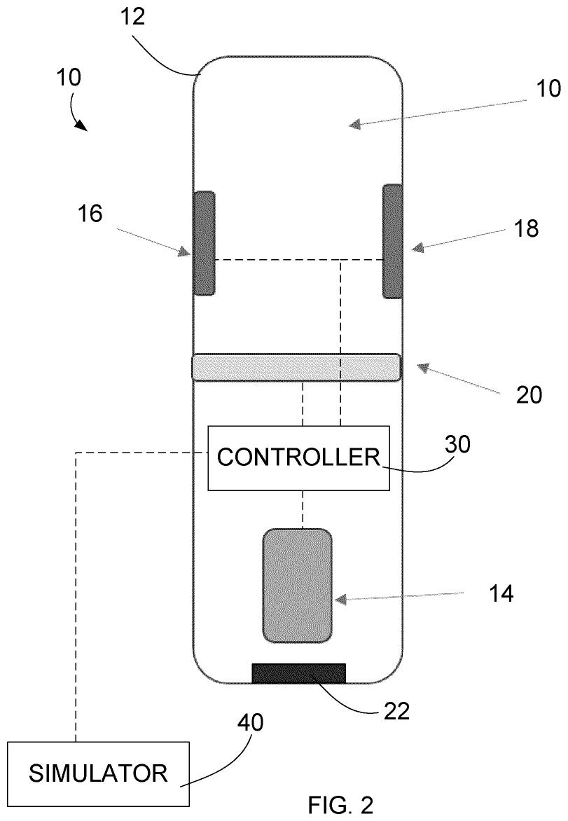

Now referring to FIG. 1, there is shown a block diagram of a haptic device 10 having a localized vibration generator(s) 16, 18, a body vibration generator 22, a motor 14, a effect mechanism 20 and a controller. The controller 30 is connected to a simulator 40 for receiving contact events therefrom. In operation, the controller provides electric signals to the localized vibration generator(s) 16, 18, the body vibration generator 22 and the motor 14 to provide haptic stimuli to a user in order to simulate haptic forces. The embodiments presented below in FIGS. 2-7 are schematic views of the haptic device 10.

Referring now to FIG. 2, a haptic device is shown at 10 that includes and provides multiple haptic modalities. The haptic device 10 may recreate all of the elements of a full realistic haptic interaction without being mechanically grounded. The haptic device 10 may include a variety of haptic modalities that may be employed to create a set of multi-type haptic cues that may provide the user with similar information that the body perceives when experiencing kinesthetic forces. The haptic device 10 may allow the user to experience the illusion of kinesthetic forces. The haptic device 10 includes a housing 12 that houses a plurality of actuators to generate multiple haptic feedbacks to the user. These actuators are described below. The housing 12 may be sized to be held in a hand of a user. The housing 12 may thus define a plurality of palm or finger-engaging locations located to be interfaced with parts of the hand of the user. Generally, the housing 12 is composed of a material provided to resist wear and deterioration, e.g. plastics.

To emulate kinesthetic forces in an arbitrary direction, the haptic device 10 uses a combination of other haptic modalities. There are at least three aspects of the sensations to recreate: transitory forces such as impacts; directionality of the force in relation to the direction of movement; and continuously applied forces. It should be understood that transitory forces are usually simulated by vibration generators, such as localized transitory forces for a localized vibration generator and transitory forces propagating in all of the haptic device for a body vibration generator, and that continuously applied forces are usually simulated by skin stretch mechanisms. However, the type of simulated force is not bound to a particular component in the present disclosure.

Transitory force magnitude may be represented by using whole body vibration or localized vibration, with the vibration magnitude created by the haptic device 10 being proportional to the transitory force magnitude expected with a ‘physical’ device. To this effect, the haptic device has a controller 30 mounted to the housing 12 and configured to drive one or more of the actuators. The controller 30 may be coupled to a body vibrotactile actuator (e.g. a body vibration generator 22, as described below), to the vibration generators 16, 18 and/or to the skin stretch mechanism 20, as will be described. Although the device 10 shown in FIG. 2 includes only the two localized vibration generators 16 and 18, it is to be understood that the haptic device 10 may include, in certain embodiments, two or more such localized vibration generators-for example one for each direction or multiple localized vibration generators such as to be able to provide several different directional vibrations to the user. Additionally, in certain embodiments, the device 10 may include a body vibration generator 22 but not any of the localized vibration generators 16, 18. The haptic device 10 therefore includes at least one vibration generator 16, 18, 22, and a skin stretch mechanism 20, as described herein. In certain embodiments, however, it may be possible for the haptic device 10 to include an impact actuator 32, as will be described below, and the skin stretch mechanism 20. Generally, the components haptic device is powered by an internal battery (not depicted), which may be rechargeable.

With particular respect to a localized vibration produced by the vibration generator(s) 16, 18, such a localized vibration may be produced at a specific isolated location in the device that is perceived by the user only at that location, whereas elsewhere in/on the device there is no vibration.

Directionality may be represented by spatial arrangement of the vibration based haptic actuators. In the embodiment shown, the haptic device includes one or more vibration generators which are spaced apart on the housing 12 of the haptic device 10. In the embodiment of FIG. 2, these localized vibration generators include, in one embodiment, a left vibration generator 16 mounted to a left side of the housing 12 and a right vibration generator 18 mounted to the right side of the housing 12. Each of these left and right vibration generators 16, 18 may be located at a respective one of the palm or finger-engaging locations to be contacted by corresponding parts of the hand of the user. If a haptic effect to the right needs to be represented, the right vibration generator 18 will be powered to represent the effect to the right. Thus, the disclosed haptic device 10 includes a plurality of regions that are engageable by the user's hand to convey the spatial nature of the interaction. The left and right vibration generators 16, 18 may be body vibrotactile actuators, or alternately they can create localized vibration by moving a portion of the body. In the case of such localized vibration produced by the vibration generators 16, 18, a vibration isolation system may be provided between the vibration region and a reminder of the body to which the actuators are mounted. They may include a motor in driving engagement with an eccentric mass to generate vibrations.

In one embodiment, the localized vibration generators 16, 18 and/or a body vibration generator 22 may include one or more actuators such as, for example, an impact actuator, an electric motor, an electro-magnetic actuator, a voice coil, a linear resonant actuator, a piezoelectric actuator, a shape memory alloy, an electro-active polymer, a solenoid, an eccentric rotating mass motor (“ERM”) or a linear resonant actuator (“LRA”), a high bandwidth actuator, an electroactive polymer (“EAP”) actuator, an electrostatic friction display, an ultrasonic vibration generator, or any combination of one or more of the above.

Additionally or alternately, in certain embodiments the haptic feedback elements 16, 18 and 22 of the haptic device 10 may include other types of haptic feedback in addition to or in lieu of the vibrations described above. For example, in one embodiment one or more of the feedback elements 16, 18 and 22 may be configured to provide an electro-tactile feedback, a temperature feedback, and/or a kinaesthetic (or semi-kinaesthetic) feedback. Such a kinaesthetic (or semi-kinaesthetic) feedback may be provided, in certain embodiments, by a pin pushing on the user's skin at a particular location or a rotary actuator rubbing on the skin at a small and localized location.

The haptic device 10 further includes a skin stretch mechanism 20 mounted to the housing 12, for example at a palm or finger-engaging location on the hand of the user (i.e. at a location of the device corresponding to the palm and/or the finger(s) of the user when holding the haptic device 10). The skin stretch mechanism 20 is coupled to the motor 14 such that the output motion provided by the motor 14 actuates the skin stretch mechanism 20. In the case of a rotary motor, rotary output of the motor 14 will be transmitted to the skin stretch mechanism 20 for actuation thereof. A gear train or other mechanism may be provided between the motor 14 and the skin stretch mechanism 20, such as to modify and/or modulate movement of the skin stretch actuator. The skin stretch mechanism 20 is used to simulate continuous or persistent forces, such as weight or continuous forces. The skin stretch mechanism 20 may be used to locally move/stretch the skin of the user. Using these modalities, the continuous force is represented in the respective output modality. For example, for skin stretch the magnitude of the continuous kinesthetic force is proportional to the amount of skin stretch the skin stretch mechanism 20 may create.

Using weight as an example, the weight of the object will be proportionally matched to the skin stretch displacement of the device. The skin stretch mechanism 20 may include, in one particular embodiment, one or more ring(s) rotatably mounted to the housing 12 and coupled to the motor 14 that is engaged to the one or more ring and is operable to induce rotation (full or partial) of the one or more ring(s). This rotation may cause the one or more ring(s) to move (displace or stretch) the skin that is in contact with said ring(s), thereby simulating continuous or persistent forces.

With the left and right side vibration generators 16, 18, the body vibration generator 22 and the skin stretch mechanism 20, the haptic device 10 may combine these three representations for a kinesthetic force to emulate the full kinesthetic force with an ungrounded device. This representation of the haptics through these cues may be amplified as the user is receiving congruent visual and audio information that is consistent with the experience that is being emulated.

Still referring to FIG. 2, the haptic device 10 may further include a controller 30 mounted to the housing 12 and operatively connected to the motor 14, the left and right vibration generators 16, 18, and the skin stretch mechanism 20 via any suitable means (e.g., wires, wireless). The controller 30 may be operatively connected to a simulator 40 (e.g., video game console). The controller 30 may receive signals from the simulator 40, the signals indicative of feedback to generate for the user of the haptic device 10. The receiving of the signals may include receiving a signal indicative that a haptic effect should be generated and the controller 30 may thus power the motor 14. The receiving of the signal indicative that the haptic effect should be generated may include receiving a signal indicative that the user experienced an impact when navigating in 3D space in a VR simulation. The receiving of the signals may include receiving a signal indicative that a directional force should be generated and the controller 30 may thus power the left or the right vibration generators 16, 18. The receiving of the signal indicative that the directional force should be generated may include receiving a signal indicative that the user experiences a force having a directional component. The receiving of the signals may include receiving a signal indicative that a continuous or persistent force should be generated and the controller 30 may thus power motor 14 to actuate the skin stretch mechanism 20. The receiving of the signal indicative that the continuous or persistent force should be generated may include receiving a signal indicative that the user is lifting something having a certain weight, pushing, or pulling on an object.

Contact events provided by a simulator 40 or by any outside commands are obtained by the controller 30, which supplies the localized vibration generator 16, 18, the body vibration generator 22 and the motor 14 with an electrical signal to generate corresponding vibrations/forces to the user's hand. It will be appreciated that the nature of the contact event may affect the nature and the intensity of the generated vibrations/forces. For instance, the user, when using the haptic device in a virtual reality game, will feel a strong impact in his hand when, e.g., hitting an object with a bat as opposed to gently touching a wall. It will be appreciated that contact events may include various types of events, such as a colliding with an object, grabbing an object, touching an object or a wall, contacting an object on a surface and the like.

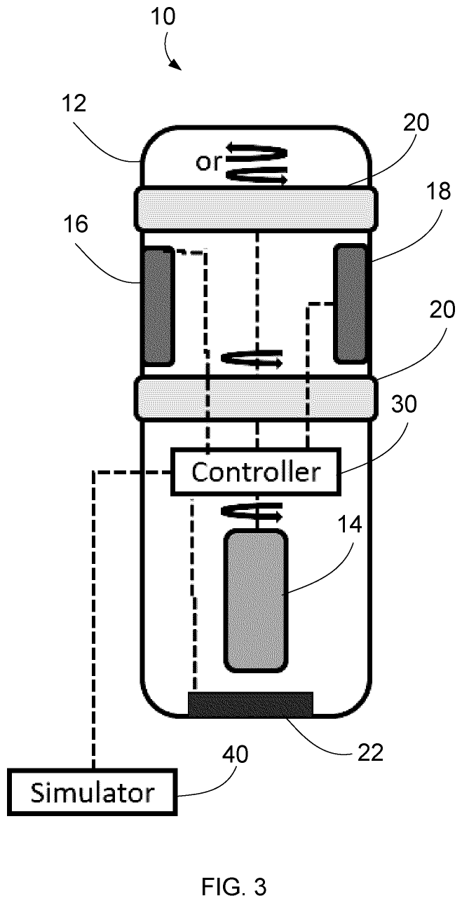

Now referring to FIGS. 3-6 are depicted exemplary embodiments of the haptic device 10 presented in FIG. 2. The housing 12 of the haptic devices 10 presented in FIGS. 3-6 each include a convertor for converting the movement generated by the motor 14. The haptic device 10 presented in FIG. 3 has similar features to the haptic device presented in FIG. 2. The skin stretch mechanism 20 presented in FIG. 3 further includes a second ring rotatably mounted to the housing 12. In this case, a rotation direction inverter (not depicted) interconnects the rings so that the direction of rotation of each ring alternates.

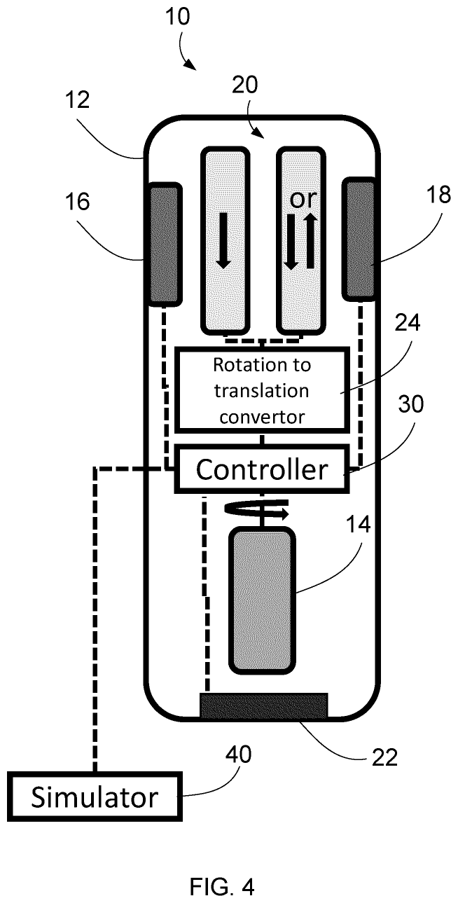

The skin stretch mechanism 20 as presented in FIG. 4 may alternately include one or more plate(s) or other elements which are movably mounted to the housing 12 and movable relative to one another moveable in translation, and/or moveable relative to the housing 12 to induce a motion of the skin in contact with the one or more plate(s) or elements. A rotation to translation converter 24 may be provided to interconnect the motor 14 and the skin stretch mechanism 20 in order to convert the rotatory force generated by the motor 14 into translatory force. The rotation to translation converter 24 is thus configured induce a translatory motion to the skin stretch mechanism 20 using the converted translatory force.

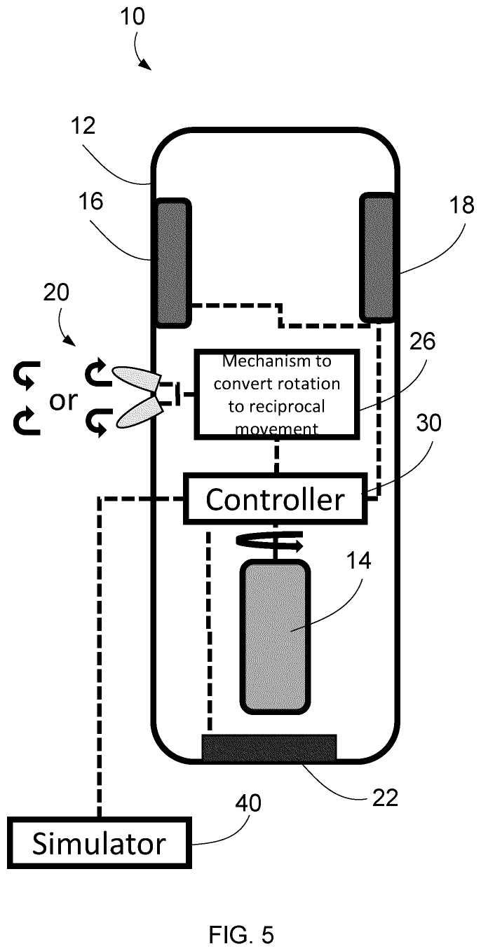

As presented in FIG. 5, the skin stretch mechanism 20 may also alternately include a pushing or pinching device used for exerting a pressure on the user's hand. In more details, pins can be used which are mounted to the housing 12 and movable relative thereto in one or more degrees of freedom. The pins extend partially outwardly from the housing 12 and are attached to a reciprocal converter 26. In some cases, the center of the pins may be rotatably coupled to the housing such that a rotation of the pins may be induced by applying a tangential force to the extremity thereof. Accordingly, the reciprocal converter 26 may be provided to interconnect the motor 14 and the skin stretch mechanism 20 in order to convert the rotatory force generated by the motor 14 for creating a pushing and pinching motion to the skin stretch mechanism 20. Such effect may be created by generating a translatory motion to the extremity of the pins attached to the reciprocal converter 26, which induces a rotation of the pins around their coupled center.

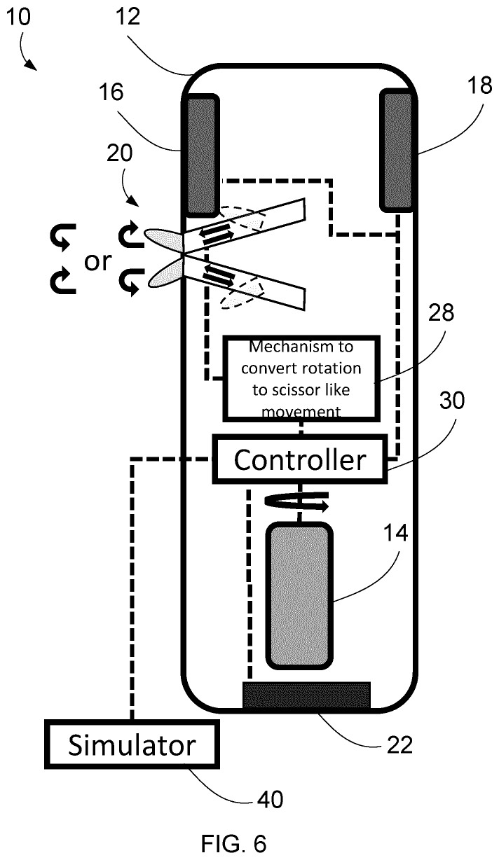

In the embodiment of the haptic device presented in FIG. 6, the skin stretch mechanism 20 includes pins that are also mounted to the housing 12 and are movable relative thereto in a plurality degrees of freedom. A rotation to scissor-like motion converter 28 interconnects the motor 14 and the skin stretch mechanism 20 to induce a similar effect as the reciprocal converter 26, but further including a translation motion in a direction that crosses the plane of the housing. As such, the moving pins of the skin stretch mechanism can translate and/or angularly displace relative to one another such that they open and close in a scissor-like motion.

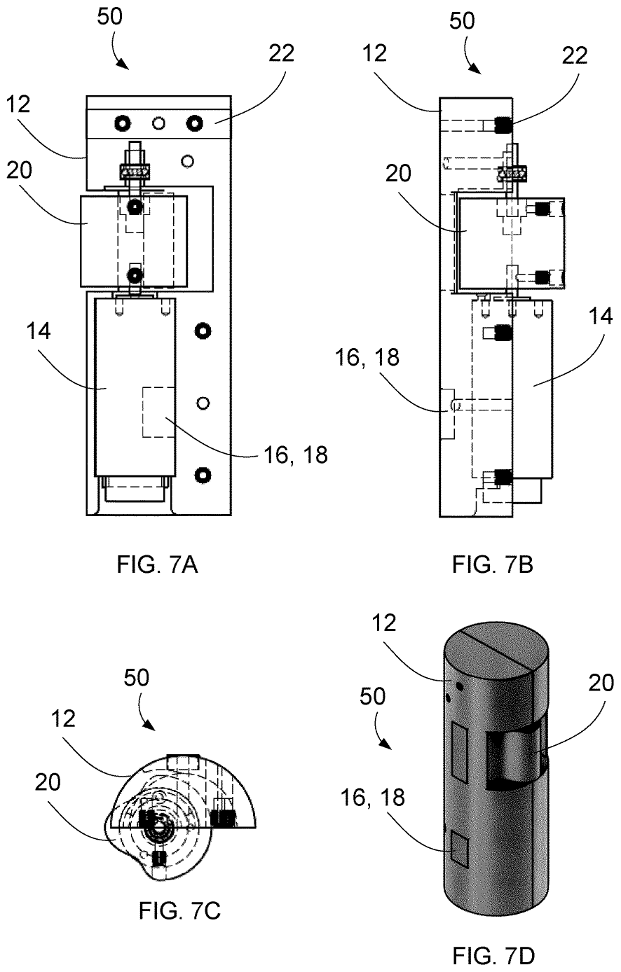

With reference to FIGS. 7A-7D, there are shown front, side, top and perspective views, respectively, on an exemplary haptic device 50. The haptic device 50 includes a housing 12 having a motor 14, a skin effect mechanism 20 and a vibration generator 16, 18 and a body vibration generator 22. The motor 14 and the skin effect mechanism 20 are concentrically aligned in a longitudinal axis such that the rotation induced by the motor 14 is transmitted directly to the skin effect mechanism 20. In the embodiment of the haptic device 50 of FIGS. 6A-6D, the skin effect mechanism 20 comprises rotating element or tubular body having a skin-contacting projection thereon. A portion of the tubular body is extending radially outward towards an opening of the housing 12, such that the eccentric portion radially extends outside the housing 12. The width of the opening is configured to be wider than the eccentric portion of the skin effect mechanism 20 in order to allow the eccentric portion to rotate within the opening in a plane orthogonal to the longitudinal axis. In operation, the skin effect mechanism 20 is in contact with the palm of a user hand, and creates a shear force thereon upon activation. In some cases, the surface of the skin effect mechanism 20 may include vibration generators. The motor 14 and the vibration generator 16, 18 and the body vibration generator 22 are controlled by a controller (not depicted) to simulate kinesthetic forces.

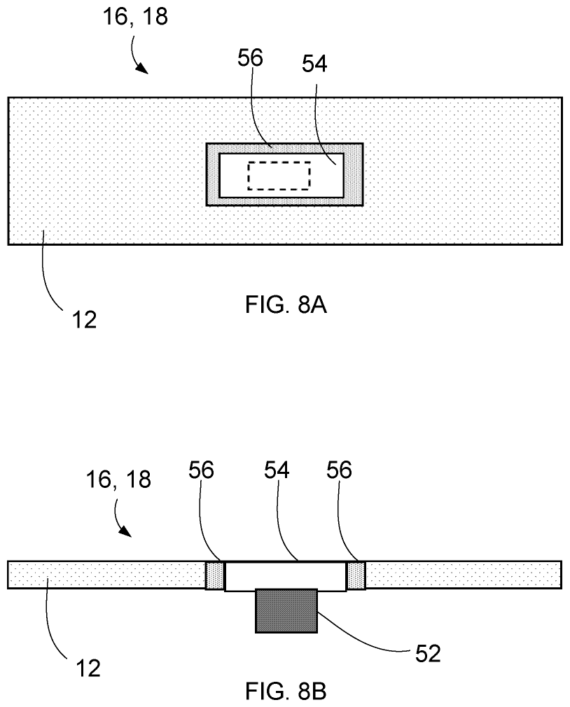

As best seen in FIGS. 8A and 8B, the localized vibration generator 16, 18 include an actuator 52 attached to a contact surface 54 embedded in the housing of the haptic device 50. The actuator 52 is placed inside the housing 12 and is therefore not in direct contact with the user. However, when activated, the actuator 52 generates vibrations that propagate through the contact surface 54, which is in contact with the user, which receives vibrations therethrough. A suspension device 56 interconnects the contact surface 54 and the housing 12 such that the vibrations generated by the actuator 52 and propagated through the contact surface 54 are dampened by the suspension device 56, which help isolate the vibrations to the localized vibration generator 16, 18. It will be understood that the actuator 52 of the localized vibration generator 16, 18 is generally configured to generate vibrations that are not perceivable by the user elsewhere on the housing but on the contact surface 54 and the suspension device 56. Conversely, the actuator of the body vibration generator 22 is generally configured to generate vibrations that propagate throughout the housing 12, irrespective to a precise location thereon.

In some embodiments, the housing 12 of the haptic device 10 includes an aperture or cut out, and the localized vibration generator 16, 18 is located in the aperture with the actuator being placed in an inner surface of the contact surface 54, the inside of the housing 12. The suspension device 56 is thus secured to the housing 12. Generally, the surface of the localized vibration generator 16, 18 is aligned with the surface of the housing so that the user is not able to differentiate the housing 12 from the localized vibration generator 16, 18 when the latter is not activated. As depicted in FIGS. 8A and 8B, the localized vibration generator 16, 18 is substantially rectangular, but can be of any other suitable shape. The contact surface 54 may be made of a material prone to propagate vibration, such as metals.

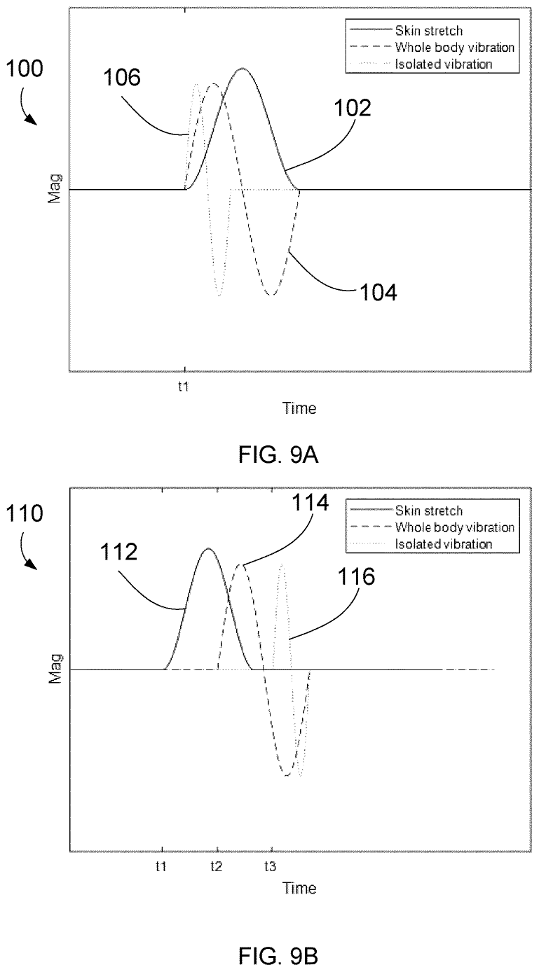

Now referring to FIGS. 9A and 9B, there is shown graphs 100, 110 having profiles 102, 104, 106, 112, 114, 116 representative of multimodal haptic stimuli generated by a haptic device. The graphs 100, 110 may be representative of the different haptic stimuli generated to mimic the sensation of a contact event in the hand of a user. The graphs 100, 110 includes three profiles, namely a haptic shear force profile 102, 112, a haptic body vibration profile 104, 114 and a haptic localized vibration profile 106, 116. Generally, the haptic shear force profile 102, 112 is generated by the skin effect mechanism 20 and has a positive amplitude value. The haptic body vibration profile 104, 114 is generated by the body vibration generator 22 and has an alternating amplitude value. The haptic localized vibration profile 106, 116 is generated by the localized vibration generator 16, 18 and has an alternating amplitude value. The profiles 102, 104, 106, 112, 114, 116 generally have a sinusoidal shape, but may have other shapes in other embodiments. For instance, the haptic shear force profile 102, 112 may alternatively have a trapezoidal shape. As depicted in FIGS. 9A and 9B, the frequency of the haptic shear force profile 102, 112 is substantially lower than the other profiles, and the frequency of the haptic localized vibration profile 106, 116 is substantially faster than the other profiles. While the amplitude of the profiles 102, 104, 106, 112, 114, 116 is substantially similar, the amplitude of each profile 102, 104, 106, 112, 114, 116 may individually vary with respect to the other profiles. It will be appreciated that while a single oscillation is depicted for each profile 102, 104, 106, 112, 114, 116, multimodal haptic stimuli may comprise a plurality of oscillation for each profile 102, 104, 106, 112, 114, 116. In some cases, the starting time of each profile 102, 104, 106, 112, 114, 116 is chosen to take into account actuator latency.

FIG. 9A depicts multimodal haptic stimuli in which all stimuli are concurrently generated at the same time. This type of multimodal haptic stimuli may be suited to represent a contact event in which the user experiences a strong impact, such as hitting an object with a bat or hitting a wall in a VR environment. Conversely, the stimuli of the multimodal haptic stimuli depicted in FIG. 9B each starts at a different time, which may be representative of a smoother contact event, such as grabbing an object or touching a wall in a VR environment.

In some embodiments where an impact actuator is used, in order to simulate an accurate resonance following a strong haptic impact impulse, the multimodal haptic stimuli starts with a haptic impact impulse profile (not depicted), and the duration of the profiles 102, 104, 106, 112, 114, 116 is proportional to the amplitude of the haptic impact impulse profile. In other words, the stronger the impact impulse the longer the duration of the haptic shear forces and the haptic vibrations.

As presented above, the controller 30 configured to control the skin effect mechanism 20, the localized vibration generator(s) 16, 18 and the body vibration generator 22 may complementarily adjust the parameters of the profiles 102, 104, 106 ,112, 114, 116 to create multimodal haptic stimuli. This can be achieved, e.g., by matching the amplitude of each stimulus so that they each can be perceived by the user, by timing the starting time and the duration of each stimulus so that the multimodal haptic stimuli accurately recreate a simulated event, such as a hitting an object or holding a bottle, and so on. It will be appreciated that configuring at least the haptic shear forces and the haptic vibrations to operate complementarily provides a vast design space for offering diverse and realistic haptic experiences.

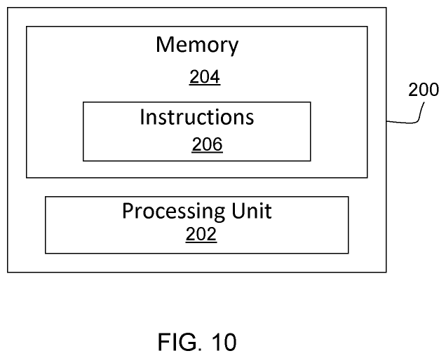

With reference to FIG. 10, an example of a computing device 200 is illustrated. For simplicity only one computing device 200 is shown but the system may include more computing devices 200 operable to exchange data. The computing devices 200 may be the same or different types of devices. The controller 30 of the haptic device 10, 50, 60 may be in communication and implemented with one or more computing devices 200.

The computing device 200 comprises a processing unit 202 and a memory 204 which has stored therein computer-executable instructions 206. The processing unit 202 may comprise any suitable devices configured to implement the method described herein such that instructions 206, when executed by the computing device 200 or other programmable apparatus, may cause the functions/acts/steps performed as part of the method as described herein to be executed. The processing unit 202 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 204 may comprise any suitable known or other machine-readable storage medium. The memory 204 may comprise non-transitory computer readable storage medium, for example, but not limited to, an electronic, magnetic, optical, electromagnetic, infrared, or semiconductor system, apparatus, or device, or any suitable combination of the foregoing. The memory 204 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 204 may comprise any storage means (e.g., devices) suitable for retrievably storing machine-readable instructions 206 executable by processing unit 202.

The methods and systems described herein may be implemented in a high level procedural or object oriented programming or scripting language, or a combination thereof, to communicate with or assist in the operation of a computer system, for example the computing device 200. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 202 of the computing device 200, to operate in a specific and predefined manner to perform the functions described herein, for example those described in the method 400.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

Herein, the expressions “about” and “substantially” include variations of up to plus or minus 5% of the respective value and/or parameter. In the context of the present disclosure, the expression “substantially” is meant to encompass slight variations, which may for example be caused by manufacturing processes, manufacturing tolerances, and so on. For instance, “substantially equal” implies slight variations of the value or property of up to plus or minus 5%. Similarly, “substantially” when used in the context of the occurrence times of different events also includes small variations of up to 5% of a total duration of the events in question.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the following description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An ungrounded haptic device adapted to be held or worn by a user for simulating kinesthetic forces, the ungrounded haptic device comprising:
a skin stretch mechanism mounted to the haptic device, the skin stretch mechanism providing haptic shear forces to skin of the user; and
a vibration generator mounted to the haptic device, the vibration generator providing haptic vibrations to the user;
wherein parameters of the haptic shear forces and parameters of the haptic vibrations are configured to operate complementarily to simulate the kinesthetic forces.

2. The ungrounded haptic device of claim 1, wherein the vibration generator comprises at least one localized vibration generator for providing haptic localized vibrations to simulate localized transitory forces.

3. The ungrounded haptic device of claim 2, wherein the localized vibration generator includes an actuator attached to an inner surface of a contact surface embedded in a housing of the haptic device.

4. The ungrounded haptic device of claim 3, further comprising a suspension device interconnecting the contact surface and the housing, the suspension device being configured to isolate vibrations generated by the localized vibration generator.

5. The ungrounded haptic device of claim 1, wherein the vibration generator comprises a body vibration generator for providing haptic body vibrations throughout the ungrounded haptic device.

6. The ungrounded haptic device of claim 1, wherein the vibration generator and the skin stretch mechanism operate concurrently during at least a portion of a total duration of simulation of the kinesthetic forces.

7. The ungrounded haptic device of claim 1, wherein the haptic vibrations are initiated concurrently with or after a starting time of the haptic shear forces.

8. The ungrounded haptic device of claim 1, wherein the maximum value of an amplitude of the haptic shear forces is greater than a maximum value of an amplitude of the haptic vibrations.

9. The ungrounded haptic device of claim 1, further comprising a motor mounted to the haptic device and coupled to skin stretch mechanism, the motor configured to induce a rotational motion to the skin stretch mechanism.

10. The ungrounded haptic device of claim 9, wherein the skin stretch mechanism comprises a rotating element having a skin-contacting projection thereon.

11. The ungrounded haptic device of claim 10, wherein the skin-contacting projection includes a surface feature and/or an eccentric portion extending radially outward from the rotating element.

12. The ungrounded haptic device of claim 10, wherein the skin stretch mechanism comprises at least one ring rotatably mounted to the haptic device.

13. The ungrounded haptic device of claim 10, further comprising a converter interconnecting the motor and the skin stretch mechanism, the converter configured for converting the rotation motion from the motor into at least one of: a translation motion; a pushing and pulling motion; and a scissor-like motion of the skin stretch mechanism.

14. The ungrounded haptic device of claim 1, further comprising an impact actuator mounted to the haptic device, the impact actuator providing an haptic impact impulse to the user to simulate an impact, wherein parameters of the haptic impact impulses, the parameters of the haptic shear forces and the parameters the haptic vibrations are configured to operate complementarily.

15. The ungrounded haptic device of claim 1, further comprising a controller for controlling the skin stretch mechanism and the vibration generator to modulate the parameters of the haptic vibrations and the haptic shear force to simulate a contact event obtained from a simulator.

16. A method of providing a user with haptic feedback using an ungrounded haptic device, the method comprising:
providing haptic shear forces to skin of the user to simulate continuous and/or persistent forces; and
complementarily with the providing of the haptic shear forces, providing haptic vibrations to the user to simulate transitory forces.

17. The method of claim 16, wherein said providing haptic vibrations further comprises providing haptic localized vibrations to simulate directional transitory forces.

18. The method of claim 16, wherein said providing haptic vibrations further comprises providing haptic body vibrations throughout the ungrounded haptic device.

19. The method of claim 16, further comprising modulating parameters of the haptic vibrations and the haptic shear force to simulate a contact event.

20. An ungrounded haptic device, comprising:
a housing adapted to be held or worn by a user;
a skin stretch mechanism mounted to the housing, the skin stretch mechanism providing shear forces to the skin of the user to simulate continuous and/or persistent forces; and
at least one of:
a vibration generator mounted on the housing for providing vibrations to the user; and
an impact actuator for providing a haptic impact impulse to the user;
wherein parameters of the haptic shear forces and parameters of at least one of the haptic vibrations and the haptic impact impulse are configured to operate complementarily.
